(19) United States
(12) Patent Application Publication
(10) Pub. No.: US 2021/0357699 A1
(43) Pub. Date: Nov. 18, 2021

(54) DATA QUALITY ASSESSMENT FOR DATA ANALYTICS

(71) Applicant: INTERNATIONAL BUSINESS MACHINES CORPORATION, ARMONK, NY (US)

(72) Inventors: Yannick Saillet, BOEBLINGEN (DE); Mike W. Grasselt, BOEBLINGEN (DE); Namit Kabra, HYDERABAD (IN); Krishna Kishore Bonagiri, HYDERABAD (IN)

(21) Appl. No.: 15/929,640

(22) Filed: May 14, 2020

(51) Int. Cl. G06K 9/62; G06N 20/20

(52) U.S. Cl. CPC G06K 9/6262; G06N 20/20; G06K 9/6268; G06K 9/6202

(57) ABSTRACT

The invention relates to an approach for data quality assessment for data analytics, the approach comprising providing a data set, the data set comprising multiple data fields, predicting by a first trained machine learning model at least one usage type of the data set using characteristics of the data fields as input, for each usage type of the at least one usage type, determining a usage specific data quality score of each of the predicted usage types, and using of the data set based on the at least one usage type and associated data quality score.

### BACKGROUND

The present disclosure relates to the field of data quality assessment. More specifically, it relates to an approach for data quality assessment for data analytics.

Data quality analysis is the process of analyzing a data set for potential data quality problems. This process may involve several types of algorithms. For example, a set of algorithms verify if the data matches a list of expectations. One algorithm may check if the data is complete, another algorithm may check that columns, which are expected to be unique do not contain any duplicated values etc.

### SUMMARY

Various embodiments provide a method for data quality assessment for a data analytics system, a computer program product and a computer system for executing the method as described by the subject matter of the independent claims. Embodiments of the present invention can be freely combined with each other if they are not mutually exclusive.

In one aspect, the invention relates to a computer implemented method for data quality assessment for a data analytics system. The method comprises: providing a data set, the data set comprising multiple data fields; predicting by a first trained machine learning model at least one usage type of the data set using characteristics of the data fields as input; determining a usage specific data quality score of each of the predicted usage types using the data fields; and using the data set based on the at least one usage type and associated data quality score.

In a further aspect, the invention relates to a computer program product comprising a non-volatile computer-readable storage medium having computer-readable program code embodied therewith. The computer-readable program code is configured to implement all of steps of the method according to preceding embodiments.

In a further aspect, the invention relates to a computer system for data quality assessment for a data analytics system. The computer system comprises a data set. The data set comprises multiple data fields. The computer system is configured for: predicting by a first trained machine learning model at least one usage type of the data set using characteristics of the data fields as input; determining a usage specific data quality score of each of the predicted usage types using the data fields; and using the data set based on the at least one usage type and associated data quality score.

### BRIEF DESCRIPTION OF THE DRAWINGS

FIG. 1 is a functional block diagram of a computer system suited for implementing the data quality assessment, in accordance with an embodiment of the present invention.

FIG. 2 is a fictional block diagram of exemplary computing environment where a computer system is connected to a network, in accordance with an embodiment of the present invention.

FIG. 3 is a flowchart depicting operational steps of a method for data quality assessment for a data analytics system, in accordance with an embodiment of the present invention.

FIG. 4 is a schematic flow diagram of an exemplary data quality assessment, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The descriptions of the various embodiments of the present invention are being presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure may enable an accurate quality assessment of a data set via a universal quality score and using the first machine learning model. The universal quality score may be provided based on a balance between usage needs of the fields of the data set and quality issues of the data fields. The accurate quality assessment of the data set may enable an efficient usage of the data set. Therefore, a resulting decision to store, process or display the data set may be a reliable one. In one example, the at least one usage type may be one usage type. In another example, the at least one usage type may be multiple usage types.

The usage specific data quality score is computed by considering the data fields of the data set on an individual basis. Data quality problems may not be equally important for the data fields. For example, even if columns are used, some quality problems may be irrelevant on some type of columns, while very relevant on some other. For instance, a missing value is relevant for a column containing a mandatory information, like an individual's name, but may be irrelevant for a column containing an optional information, like a secondary phone number. While in another example, a data format problem on a secondary phone number may be relevant. Identified data quality problems may have a different importance depending on what the user intends to do with the data. In addition, a user may have preferences, which are field dependent.

According to one embodiment, the method further comprises: for each usage type of the at least one usage type, determining for each field of the data fields a usage weight, wherein determining the usage specific data quality score comprises calculating the usage specific data quality score using the determined usage weights.

According to one embodiment, the method further comprises: for each usage type of the at least one usage type and for each field of the data fields, determining a relevance weight for each data quality problem of a set of predefined data quality problems, the relevance weight of a data quality problem for a field indicating a relevance of the data quality problem, wherein determining the usage specific data quality score comprises calculating the usage specific data quality score using the determined relevance weights and/or the usage weights. The relevance weight of a data quality problem may be determined so that it is the same for all the data fields of the data set. In another example, the relevance weight of a data quality problem may be field dependent so that it is determined, e.g. dependent on a characteristic of the field, for each field of the data fields.

Using both the usage weights and the relevance weights may be advantageous. For example, some data sets may contain optional or unused information on which a high number of quality issues may be identified, which have no real impact on the usage of the data set (e.g. finding missing values in a sparsely filled optional column, which is not used for analytics purposes). In another example, a data set containing many “irrelevant” columns may get a low-quality score, as all identified problems are only on unused columns.

Each data quality problem of the set of data quality problems may, for example, be determined for a given field by determining if the values of the field fulfill an expectation of what should be a valid value of the field. For example, the determining that the values of the field fulfill the expectation comprises comparing the values of the field with reference values of the field or determining whether the values of the field fulfill predefined relations between the values of the field and other fields of the data set. The relevance weight of a data quality problem for a field indicates a relevance of the data quality problem. The relevance weight may, for example, be user defined.

The characteristic of the field may, for example, comprise a domain of the field, a precision of values of the field, a data type of values of the field, data classes matching the values of the field, a distribution or statistics of the values of the field, eventual business terms or business classification associated to the field, a name or description of the fields, a number of values in the field etc. A domain of a field may be the set of all unique values permitted for the field. The type of the field may, for example, comprise a string type, float type etc. The precision may be available if the data type requires a precision specification.

The term “data set” as used herein refers to a collection of data such as, for example, a data table or a list. The collection of data may be presented in a format that enables the extraction of the sets of features to be input to the set of machine learning models. For example, the collection of data may be presented in tabular form. Each field (or column) may represent a particular variable or attribute. Each row may represent a given member, record or entry of the data set. The collection of data may be presented in other formats such as JSON like format, NoSQL database, XML format etc. The terms column and field are interchangeably used herein.

The term “machine learning” (ML) refers to a computer algorithm used to extract useful information from training data sets by building probabilistic models (referred to as machine learning models or “predictive models”) in an automated way. Machine learning algorithms build a mathematical model based on sample data, known as “training data”, in order to make predictions or decisions without being explicitly programmed to perform the task. The machine learning may be performed using a learning algorithm such as supervised or unsupervised learning, [clustering, classification, linear regression,] reinforcement algorithm, self-learning, etc. The machine learning may be based on various techniques such as clustering, classification, linear regression, support vector machines, neural networks, etc. A “model” or “predictive model” may for example be a data structure or program such as a neural network, a support vector machine, a decision tree, a Bayesian network etc. The model is adapted to predict an unmeasured value (e.g. which tag corresponds to a given token) from other, known values and/or to predict or select an action to maximize a future reward. According to one example, the machine learning model is a deep learning model.

According to one embodiment, the method further comprises predicting the usage weights by a second trained machine learning model using the characteristics of the data fields as input. The second machine learning model may predict the importance of a column for a usage type/intent. Using another machine learning model at another stage of the data quality assessment may further increase the accuracy of the determined quality of data set.

According to one embodiment, the method further comprises predicting the usage weights using simulation data obtained using an analytical model descriptive of the predicted usage types as a function of the data fields. This may enable, for example, the computation of the column weights by running a simulation of the intended analytics and analyzing the results to find out which columns are found by the analytics algorithm to play a role in the analytics and which columns do not. Using the simulation may save processing resources that would otherwise be required for using real data.

According to one embodiment, the method further comprises predicting each relevance weight of the relevance weights by a third trained machine learning model using characteristics of the data fields as input. The third machine learning model may predict the relevance of a data quality problem type for a particular type of columns and a usage intent. Using another machine learning model at a different stage of the data quality assessment may further increase the accuracy of the determined quality of data set.

In another example, the usage weights and/or relevance weights may be predicted using static rules. A static rule may, for example, indicate: if the usage intent is to build a predictive model, columns containing, for example, name, address, phone number or IDs are not relevant and should be weighted to 0.

In another example, the usage weights and/or relevance weights may be predicted using correlation matrices between the columns. The correlation matrices may be automatically computed to find out which columns are likely to play a role or not in the usage intent of the user.

In another example, the usage weights and/or relevance weights may be predicted as follows. A dry run of analytics may be done in the background to find out the relevant columns. For example, if the usage intent is to predict a column, a model may be built in the background to find out which columns are chosen by the algorithms as probable relevant columns and which columns are not relevant, and use that knowledge to adjust or evaluate the usage weights of the columns for computing the usage specific data quality score.

The three machine learning models may be trained using the same or different training data sets. The training data set(s) may be built using a history of usage or processing of the data set or of data sets similar to the data set. For example, the first machine learning model may be trained using a first training set, the second machine learning model may be trained using a second training set and the third machine learning model may be trained using a third training set. The first, second and third training sets may be the same or different.

The first training set may, for example, be obtained using historical information from logs and data lineage, using as an input all terms identified in the data set and may be used to build the training set. For this, an apriori algorithm may be used. The apriori algorithm may be trained on transactions made up of all terms associated with any field of the data set and the actions that were done on that data set and build association rules with an action in the head of the rule.

The third training set may, for example, comprise historical data indicative of columns, for which the user manually ignored problems. That is, that the problem is irrelevant e.g. relevance weight is low, for these columns. The historical data may further indicate columns for which the user took actions, such as adjusting the relevance weight of the data quality problem in the columns.

For example, the first training set may comprise entries, wherein each entry may associate a usage type with one or more characteristics of the fields of the data set. The second training set may comprise entries, wherein each entry may associate a usage weight of a field with one or more characteristics of the field and with a given usage type. The third training set may comprise entries, wherein each entry may associate a relevance weight of a data quality problem for a field with one or more characteristics of the field.

According to one embodiment, the method further comprises providing the at least one usage type and associated data quality score and in response to the providing of the at least one usage type and associated data quality score, the method further comprises receiving a selection of a usage type of the provided usage types using the associated quality scores. For example, a list of predicted usage types of the data set associated with the corresponding data quality scores may be presented to a user. The presenting may comprise prompting the user for selecting among the presented usage types. The selected usage type may be applied on the data set. This may prevent unnecessary processing of the data set using non-user-preferred usage types. The data set may be used in accordance with the selected usage type.

According to one embodiment, the data set is automatically used in accordance with the at least one usage type and associated data quality score.

According to one embodiment, the data set may be automatically used in accordance with a given usage type of the at least one usage type, based on a comparison result of the data quality score of the given usage type and a predefined threshold. This may prevent waste of resources for processing low scored data.

According to one embodiment, the using of the characteristics of the data fields as input of the first machine learning model comprises classifying the fields using a data field classifier and using the results of the classification as input to the first machine learning model. For example, the data field classifier may be a program configured to perform the data classification. The data classification comprises a determination of characteristics of a data field. The data classification may enable to identify a class or category of a field. The output of this step may be a list of terms or tags which are associated automatically to each data field and to the data set.

According to one embodiment, the usage of the data set comprises processing the data set in accordance with one or more data analysis and storing at least part of the data set. In another example, the data set may be provided as an input or a source for an extract transform load (ETL) process or as a source for building data reports.

The usage types that have been used for using/processing the data set, the relevance weights and the usage weights of the data set and the characteristics of the fields may be used to update the training data set(s). The updated training data sets may be used to retrain the first, second, third and/or machine leaning models. For example, the user choice of the data set usage can be used as new input data to retrain at regular interval the model for predicting the data set usage. In other words, the training of the model may be based on an actual user action or at least a prediction confirmed by the user. This may prevent that the model diverge to something unusable, where each prediction reinforces the same prediction in the future.

According to one embodiment, the data quality problems comprise at least any one of the following: missing values, duplicated data, incorrect data and syntactically incorrect data or violation of defined constraints and rules, incomplete values, unstandardized values, outliers, biased data, syntactically correct but unexpected values. Standardization refers to a process of transforming data into a predefined data format. The data format may include a common data definition, format, representation, and structure. An unstandardized value may be a value which does not fit into a known data format.

According to one embodiment, the usage types comprise at least anyone of the following: generation of predictive models and record clustering, usage as a source for a certain data flow (extract transform and load; ETL), usage as a source to feed a report, executing a predefined data analysis, and storing the data set.

Embodiments of the present invention may be implemented using a computing device that may also be referred to as a computer system, a client, or a server.

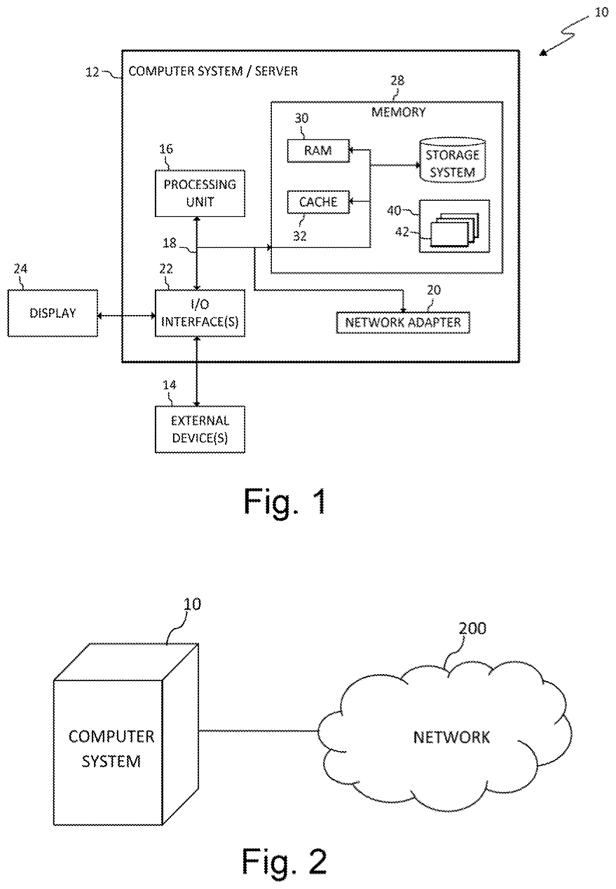

Referring now to FIG. 1. FIG. 1 is a functional block diagram of a computer system suited for implementing the data quality assessment, in accordance with an embodiment of the present invention. Computer system 10 is only one example of a suitable computer system and is not intended to suggest any limitation as to the scope of use or functionality of embodiments of the invention described herein. Regardless, computer system 10 is capable of being implemented and/or performing any of the functionality set forth hereinabove.

In computer system 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

A computer system such as the computer system 10 shown in FIG. 1 may be used for performing operations disclosed herein such as data quality assessment for a data analytics system. The data quality assessment may comprise providing a data set, the data set comprising multiple data fields, wherein values of the data fields are indicative of a relevance weight of each data quality problem of a set of predefined data quality problems; predicting by a first trained machine learning model at least one usage type of the data set using characteristics of the data fields as input; for each usage type of the at least one usage type, determining for each field of the data fields a usage weight; calculating a usage specific data quality score of each of the predicted usage types using the relevance weights of the set of data quality problems in each field of the data set and the usage weights; and using of the data set based on the at least one usage type and associated data quality score. The computer system 10 may comprise a data set. This data set may comprise multiple data fields, wherein values of the data fields are indicative of a relevance weight of each data quality problem of a set of predefined data quality problems. Such computer system may be a standalone computer with no network connectivity that may receive data to be processed, such as a data set, the data set comprising multiple data fields, wherein values of the data fields are indicative of a relevance weight of each data quality problem of a set of predefined data quality problems, through a local interface. Such operation may, however, likewise be performed using a computer system that is connected to a network such as a communications network and/or a computing network.

FIG. 2 is a functional block diagram of exemplary computing environment where a computer system is connected to a network, in accordance with an embodiment of the present invention. A computer system such as computer system 10 is connected, e.g. using the network adapter 20, to a network 200. Without limitation, the network 200 may be a communications network such as the internet, a local-area network (LAN), a wireless network such as a mobile communications network, and the like. The network 200 may comprise a computing network such as a cloud-computing network. The computer system 10 may receive data to be processed, e.g. a data set comprising multiple data fields, wherein values of the data fields are indicative of a relevance weight of each data quality problem of a set of predefined data quality problems, from the network 200 and/or may provide a computing result, such as a usage specific data quality score of each of the predicted usage types using the relevance weights of the set of data quality problems in each field of the data set and the usage weights, to another computing device connected to the computer system 10 via the network 200.

The computer system 10 may perform operations described herein, entirely or in part, in response to a request received via the network 200. In particular, the computer system 10 may perform such operations in a distributed computation together with one or more further computer systems that may be connected to the computer system 10 via the network 200. For that purpose, the computing system 10 and/or any further involved computer systems may access further computing resources, such as a dedicated or shared memory, using the network 200.

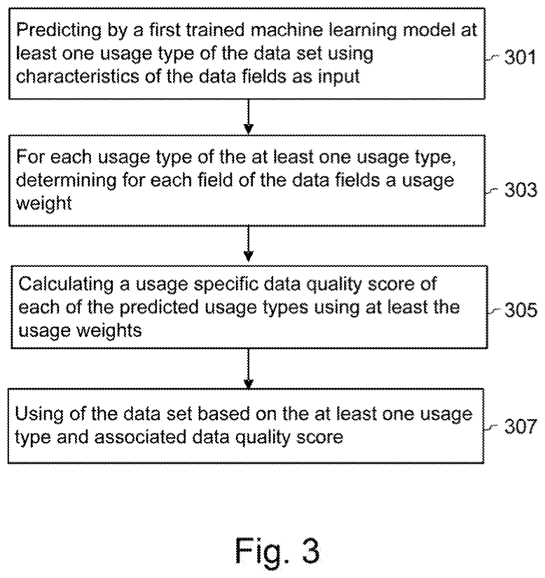

FIG. 3 is a flowchart depicting operational steps of a method for data quality assessment for a data analytics system, in accordance with an embodiment of the present invention e.g. using the infrastructure of FIG. 1.

The data set comprises data fields. For each data quality problem of a set of predefined data quality problems: each data field of the data fields may be associated with a relevance weight indicative of the relevance of the respective data quality problem for a given usage type. The relevance weights may be received before performing the present method or may be computed as described herein. The relevance weights may enable the weight of the set of data quality problem types for each column to reflect their importance for the given column for the given usage type of the data set.

The set of data quality problems may for example be predefined or may automatically be identified by the present method.

In step 301, usage types of a data set may be predicted by a first trained machine learning model. This may enable a first trained machine learning model to assess the most probable possible usage of the data set. For example, in response to receiving a request to analyze the data set, characteristics of the fields of the data set may be input into the first machine learning model. The first machine learning model may then output a prediction of the usage types of the data set. The characteristics of the fields may be obtained using a classifier. From the classification of the columns and of the data sets, some user actions are more probable than others.

For instance, if the data set contains demographic information, one possible usage type can be to use a clustering algorithm to do a customer segmentation. If the data set contains some fields that can be classified, as some monetary value or some quantity or categorical values, possible usage types may be to build predictive models against these columns. However, a user may not build a predictive model on a column containing person names, addresses or other non-repeatable values. Even for categorical demographic columns (like gender, profession), the user may not be interested in building a predictive model for them, while columns like “revenue”, “churn”, etc. may be more probable to be the target of predictive models.

For each usage type of the usage types, a usage weight may be determined in step 303 for each field of the data fields. For example, the usage weight may indicate the importance of a field for a given usage type. For example, a user may be prompted in step 303 to provide the usage weights and the usage weights may be received as input from the user. In another example, a second trained machine learning model may be used to predict the usage weight of each field for each usage type. The usage weights may enable the weight of the different columns of the data set to reflect their importance for each predicted usage type of the data set.

This may result in a set of weights associated with each field of the data fields. The set of weights may comprise the relevance weights and usage weights.

In step 305 a usage specific data quality score of each of the predicted usage types may be calculated using the relevance weights of the set of data quality problems in each field of the data set and the usage weights. The usage specific data quality score (DQScore) may be computed using field specific data quality scores (DQScore(Fieldᵢ)) defined for each field of the data fields. For example, the usage specific data quality score DQScore may be a combination (e.g. average) of the field specific data quality scores DQScore(Fieldᵢ). The usage specific data quality score DQScore, may for example be defined for a give usage type and a set of m data quality problems as follows

$$DQScore ( data Set ) = \frac{1}{n} {\sum }_{i = 0}^{n} D Q S c o r e ( F i e l {d}_{i} ) ,$$

where DQScore(Fieldᵢ)=100%−weight_{Field}_{ᵢ}·Σⱼ₌₀^{m}weight_{pb}_{ⱼ}_{for Field}_{ᵢ}·freq(pbⱼ in Fieldᵢ), weight_{Field}_{ᵢ} is the usage weight, and weight_{pb}_{ⱼ}_{for Field}_{ᵢ} is the relevance weight of the data quality problem j for the field i, freq(pbⱼ in Fieldᵢ) is the frequency of the problem j in field i (e.g. percentage of the values in the field which have the problem j).

This indicates that the field specific data quality score is 100% subtracted by the frequencies of all data quality problems. The frequencies of the data quality problems are weighted by the relevance weight of the data quality problems and the sum is weighted by the usage weight of the field. If the field specific data quality scores (DQScore(Fieldᵢ) is negative it may be set to 0. In another example, the usage specific data quality score may be determined based on a user input in step 305, e.g. the user input may comprise the usage specific data quality score of each of the predicted usage types of the data set.

This may provide an example implementation of the following embodiment of the method described above, wherein the method further comprises processing the data set for identifying a frequency of each data quality problem of the set of data quality problems in each data field of the data fields, wherein the usage data quality score is related to the frequencies by a function, the function being indicative of an impact of the frequencies on the usage data quality score, wherein calculating the usage specific data quality score comprises modifying the impact of the frequencies by applying the respective determined relevance weights.

Step 305 may result in a data quality score per usage type of the predicted usage types. Based on the usage specific data quality scores associated with the respective usage types, the data set may be used in step 307 accordingly. For example, for a given usage type the data set may be used, if the usage specific data quality score is higher than a predefined threshold.

All or part of the predicted usage types of step 301 may be used in step 307 in order to use (e.g. process) the data set. For that, in one example, all predicted usage types may be presented with their associated data quality scores to a user. The user may select one usage type of the presented usage types for the data set. The selected usage type(s) may be used to process the data set in step 307. The user choice of the data set usage may be used as new input data to retrain at regular interval the model for predicting the data set usage. For example, the usage types that have been used in step 307, the relevance weights and usage weights of the data set and the characteristics of the fields may be used to retrain, the first, second and/or third machine learning model.

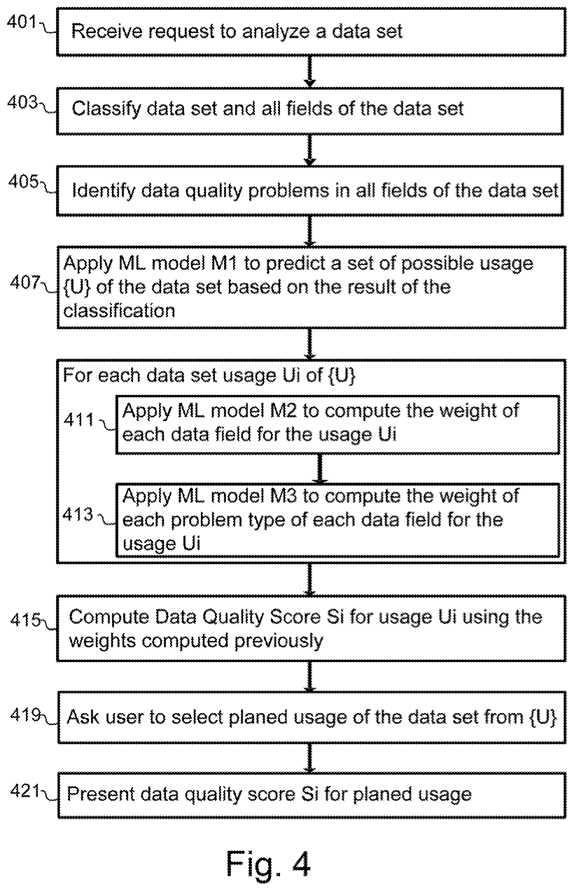

FIG. 4 is a flowchart of an exemplary method for data quality assessment for a data analytics system. In step 401 a data analysis request to analyze a data set may be received. In response to receiving the data analysis request, the data set and all fields of the data set may be classified in step 403. The output of this step may be a list of terms or tags, which may be associated automatically to each data field and to the data set. Based on the classification of the fields of the data set, some user actions may be more preferable than others. For instance, a user may avoid trying to build a predictive model on a field containing person names, addresses or other non-repeatable values, however the user may be interested in fields like “revenue”, “churn”, etc. . . . , which may be more probable to be the target of predictive models.

Data quality problems in all fields of the data set may be identified in step 405. In step 407, a first ML model may be used to predict a set of possible usages of the data set based on the results of the classification. The first ML model may predict which possible usage a user may expect for a data set having the classification, as disclosed in step 403. For instance, if a data set contains demographic information, a possible usage may be a record clustering algorithm to do a customer segmentation. In case the data set contains some fields that can be classified, as monetary value, quantity or categorical values, possible user actions may be to build predictive models against these fields.

For each predicted usage type: a second ML model may be used in step 411 to determine the weight of each data field for said usage type. In step 413, further a third ML model may be used to determine the weight of each problem type for each data field of the data set. In step 415, a usage specific data quality score may be computed for the usage type using the weights computed in steps 411 and 413.

In step 419, the user may be asked to select one usage type of the predicted usage types for the data set. This may be performed by displaying the predicted usage types and associated computed quality scores. In step 421 the usage specific data quality score and the data quality report to reflect the set of weight, which is relevant for the chosen analytics intent, may be adjusted automatically.

In one example, the computer-implemented method for data quality assessment for a data analytics system comprises inputting a data set, the data set comprising multiple data vectors; classifying the data vectors according to a type of data included in the data vectors; calculate quality metrics related to at least some of the data vectors; predicting at least one possible usage type based on a result of the classifying, the predicting comprising applying a first machine learning model on the result of the classifying; and calculating a usage specific data quality metric describing the quality of the data set from the quality metrics. This exemplary method may comprise estimating an importance metric related to a data vector and specific for a certain usage type, the estimating comprising applying a second machine learning model on the respective usage type and the result of the classifying. Hereby, calculating the usage specific data quality metric may comprise deriving weight factors from the individual importance metrics and calculating a weighted sum of the quality metrics based on the weight factors. The data vector may, for example, be a data field.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for data quality assessment for a data analytics system, comprising:
providing a data set, the data set comprising multiple data fields;
predicting by a first trained machine learning model at least one usage type of the data set using characteristics of the data fields as input;
determining usage specific data quality scores of the at least one usage type using the data fields; and
using of the data set based on the at least one usage type and the data quality scores.

2. The method of claim 1, further comprising: for the at least one usage type, determining for the data fields one or more usage weights, wherein determining the usage specific data quality score comprises calculating the usage specific data quality score using the one or more usage weights.

3. The method of claim 2, further comprising: for the at least one usage type, and for the data fields, determining one or more relevance weights for a set of predefined data quality problems, wherein the one or more relevance weights indicate a relevance of the data quality problems, wherein determining the usage specific data quality scores comprises calculating the usage specific data quality scores using the one or more relevance weights and the one or more usage weights.

4. The method of claim 1, further comprising: for the at least one usage type, and for the data fields, determining one or more relevance weights for a set of predefined data quality problems, wherein the one or more relevance weights indicate a relevance of the data quality problem, wherein determining the usage specific data quality score comprises calculating the usage specific data quality score using the determined relevance weights.

5. The method of claim 3, further comprising processing the data set for identifying a frequency of occurrences of one or more data quality problems of the set of data quality problems in one or more of the data fields, wherein the usage data quality score is related to the frequency of occurrences by a function, the function being indicative of an impact of the frequency of occurrences on the usage data quality score, wherein calculating the usage specific data quality score comprises modifying the impact of the frequency of occurrences by applying the respective one or more relevance weights.

6. The method of claim 2, further comprising predicting the one or more usage weights by a second trained machine learning model using characteristics of the data fields as input.

7. The method of claim 2, further comprising predicting the one or more usage weights using simulation data obtained using an analytical model descriptive of the at least one usage type as a function of the data fields.

8. The method of claim 3, further comprising predicting the one or more relevance weights by a third trained machine learning model using characteristics of the data fields as input.

9. The method of claim 1, further comprising:
providing the at least one usage type and data quality scores and in response to the providing, receiving a selected usage type of the provided at least one usage type using the data quality scores.

10. The method of claim 8, wherein the data set is used in accordance with the selected usage type.

11. The method of claim 1, wherein the data set is automatically used in accordance with the at least one usage type and data quality scores.

12. The method of claim 11, wherein the data set is automatically used in accordance with a first usage type of the at least one usage type, based on a comparison result of a data quality score of the first usage type and a predefined threshold.

13. The method of claim 1, wherein the using of the characteristics of the data fields as input of the first machine learning model comprises classifying the data fields using a data field classifier and using the results of the classification as input to the first machine learning model.

14. The method of claim 1, further comprising:
retraining the first machine learning model based on the at least one usage type used of the data set.

15. The method of claim 1, wherein the data quality problems comprise at least one of the following: missing values, duplicated data, incorrect data, syntactically incorrect data, violation of defined constraints, violation of defined rules, incomplete values, unstandardized values, outliers, biased data or syntactically correct but unexpected values.

16. The method of claim 1, wherein the usage types comprise at least one of the following: generation of predictive models, generation of record clustering, usage of the data set as a source for a certain extract transform and load (ETL) data flow or usage of the data set as a source to feed a report.

17. A computer program product for data quality assessment for a data analytics system comprising a non-volatile computer-readable storage medium having computer-readable program code embodied therewith, the computer-readable program code being configured to implement the following, when being executed by a computer system:
providing a data set, the data set comprising multiple data fields;
predicting by a first trained machine learning model at least one usage type of the data set using characteristics of the data fields as input;
determining a usage specific data quality score of each of the predicted usage types using the data fields; and
using of the data set based on the at least one usage type and associated data quality score.

18. The computer program product of claim 17, further comprising: for the at least one usage type, determining for the data fields one or more usage weights, wherein determining the usage specific data quality score comprises calculating the usage specific data quality score using the one or more usage weights.

19. A computer system for data quality assessment for a data analytics system, the computer system being configured for:
providing a data set, the data set comprising multiple data fields;
predicting by a first trained machine learning model at least one usage type of the data set using characteristics of the data fields as input;
determining a usage specific data quality score of each of the predicted usage types using the data fields; and
using of the data set based on the at least one usage type and associated data quality score.

20. The computer system of claim 19, further comprising: for the at least one usage type, determining for the data fields one or more usage weights, wherein determining the usage specific data quality score comprises calculating the usage specific data quality score using the one or more usage weights.
